(19) United States
(12) Patent Application Publication
(10) Pub. No.: US 2008/0206542 A1
(43) Pub. Date: Aug. 28, 2008

(54) Ceramic matrix composite abradable via reduction of surface area

(75) Inventors: Steven J. Vance, Orlando, FL (US); Gary B. Merrill, Orlando, FL (US)

Correspondence Address: Siemens Corporation;Intellectual Property Department, 170 Wood Avenue South, Iselin, NJ, 08830, US

(73) Assignee: Siemens Power Generation, Inc.

(21) Appl. No.: 11/709,698

(22) Filed: Feb. 22, 2007

(51) Int. Cl. B32B 3/26

(52) U.S. Cl. 428/304.4

(57) ABSTRACT

A ceramic matrix composite with an enhanced abradability has a patterned surface with an array of solid composite material and voids where the voids extend into but not through the composite. The flow of gas through the voids as the surface is traversed by an impinging component, such as a turbine blade tip, is inhibited by the shape and size of the voids which can be sealed by the passing blade tip. Separately or additionally the inhibition of gas flow can result from the filling of the voids with a ceramic material of higher abradability than the ceramic matrix composite.

### FIELD OF THE INVENTION

The invention relates to ceramic matrix composites and more particularly to ceramic matrix composites with enhanced abradability.

### BACKGROUND OF THE INVENTION

Most components of combustion turbines require the use of a coating or insert to protect the underlying support materials and structure from the very high temperatures of the working environment. Ceramic matrix composite (CMC) structures have been developed for these coatings to provide the high temperature stability of ceramics without the intrinsic brittleness and lack of reliability of monolithic ceramics. Although these coatings must resist erosion from the severe environment they are also required to preferentially wear or abrade as necessary. For example, to maintain turbine efficiency between stages, the turbine ring seal must maintain a tight tolerance with the tips of the turbine blades. The surface of the ring seal must abrade when impacted by the blade tips to reduce damage to the blades and to maintain a tight tolerance.

A number of types of abradable coatings for CMC components have been developed. Merrill et al., U.S. Pat. No. 6,641,907 teaches a coating that has come to be known as a friable graded insulation, (FGI), with temperature stability up to temperatures approaching 1700° C. Other known coating systems are less thermally stabile, less capable of providing erosion resistance, and display an inferior thermal expansion match with the substrate, poorer bonding to the substrate, lower flexibility, and lower abradability at temperatures in the range of 1600° C.

Although FGI works well for high incursion rates when cubic boronnitride (cBN) coated turbine blade tips, at low incursion rates FGI does not perform adequately. Low incursion rates are common of large land-based gas turbines and for rub cases which occur beyond the practical life of cBN abrasive tip treatments.

### SUMMARY OF THE INVENTION

A ceramic matrix composite component with an abradable surface has a pattern of composite and voids with the voids having a depth of less than the composite thickness and where voids are 60 to 90 percent of the surface and the component has a means to restrict gas flow through the void while an impinging blade passes over the void. The means to restrict gas flow can be discontinuous voids where the voids have dimensions that permit sealing of the void by the blade's tip while passing over the void. Another means to restrict gas flow is filler deposited in the void. The filler is a ceramic material. The ceramic filler can be phosphates, silicates, zirconates or hafnates.

The pattern can be a regular array of composite with square top surfaces surrounded by the void and the means to restrict gas flow is filler. Rows of the square tops are preferentially aligned at a 30 or a 60 degree angle to the direction of the blade path. The pattern can be a regular array of the composite with square top surfaces connected by narrow ligaments partitioning the voids into discontinuous crosses and the means to restrict gas flow is discontinuous voids. The discontinuous voids can include filler. Rows of the square tops are preferentially aligned at a 30 or a 60 degree angle to the direction of the blade path. The pattern can be a regular array of circular voids surrounded by the composite and the means to restrict gas flow can be discontinuous voids or discontinuous voids with included filler. The circular voids are preferentially aligned at a 30 or a 90 degree angle to the direction of the blade path. The pattern can be a regular array of hexagonal voids surrounded by the composite where the means to restrict gas flow is discontinuous voids or discontinuous voids with included filler. The pattern can be a regular array of elliptical voids surrounded by the composite where the means to restrict gas flow can be discontinuous voids or discontinuous voids with included filler. The rows of the elliptical voids are preferentially aligned at a 30 or a 60 degree angle to the direction of the blade path. The pattern is a regular array of cross shaped voids surrounded by composite where the means to restrict gas flow comprises discontinuous voids or discontinuous voids with included filler.

### BRIEF DESCRIPTION OF THE DRAWINGS

FIG. 1 is a perspective view of a portion of a CMC component with a pattern of composite squares disposed at a 30-degree angle to the edge.

FIG. 2 is the component of FIG. 1 where filler is deposited in the voids.

FIG. 3 is a perspective view of a portion of a CMC component with a pattern of composite squares connected by ligaments where the resulting voids are in the shape of crosses.

FIG. 4 is the component of FIG. 3 where filler is deposited in the voids.

FIG. 5 is a perspective view of a portion of a CMC component with a pattern of circular voids.

FIG. 6 is the component of FIG. 5 where filler is deposited in the voids

FIG. 7 is a perspective view of a portion of a CMC component with a pattern of elliptical voids disposed at a 30-degree angle to the edge.

FIG. 8 is the component of FIG. 7 where filler is deposited in the voids.

FIG. 9 is a perspective view of a portion of a CMC component with a pattern of hexagonal voids.

FIG. 10 is the component of FIG. 9 where filler is deposited in the voids.

FIG. 11 is a top view of perspective view of a coated CMC component where a series of voids in the shape of crosses.

### DETAILED DESCRIPTION OF THE INVENTION

The present invention provides a ceramic matrix composite (CMC) components used in combustion turbines with a significantly improved abradability. The surface of the CMC comprises a pattern of voids at the surface of the composite where the voids continue to a predetermined depth. The predetermined depth is chosen to be approximately equal to the final anticipated depth of abrasion to a component, such as a ring segment of a gas turbine, upon impact by another component, such as the tip of a turbine blade, after commissioning. The depth is less than the thickness of the composite. The shape of the composite and voids in the pattern can vary. Although nearly any shape is possible, the shape can be that of regular polygons, circles, ellipses, and are chosen primarily for ease of processing and to inhibit the flow of gas through the void during the functioning of the component, as leakage about a turbine blade during the operation of a turbine can significantly reduce the turbine's efficiency. Multiple shapes can be present on a given component surface. The walls of composite material defining the voids can be perpendicular to the top surface or can be oriented at an angle other than 90 degrees.

The voids can be formed by the removal of composite material from the continuous solid composite surface by a method such as ultrasonic machining. Other methods include end-milling, drilling, laser ablation, and electron beam ablation. An alternative to the removal of composite material from the surface of the component is to prepare the composite in a manner where voids at the surface result from the method of forming the composite. Filament winding is one method of forming CMC structures that can generate a regular pattern of voids at the surface with some control of the void depth and shape. Controlling the winding parameters such as the winding angle, repeat pattern, filament tow size, filament tension, and band width can generate a surface with voids of a predetermined shape and depth in a predetermined pattern. Autoclave processing using a fugitive insert below the surface of the CMC to generate a surface profile is another such method.

For a CMC with an abradable surface a goal of the invention is that voids occupy 50 percent or more of the surface area and preferably 60 to 90 percent of the surface area. It is also a goal of the invention to remove material in a pattern such that the path of the blade tip can achieve uniform cutting with the blade tip displaying nearly uniform wear. The most uniform wear is achieved by having a specific orientation of the pattern relative to the blade path. By the proper orientation of the pattern to the blade path over the component, the entire impinging portion of the blade encounters approximately the same amount of composite as it sweeps across the surface. This orientation depends upon the shape of features in the pattern.

One feature of the invention is to have a means by which leakage of gas through the voids is partially or fully inhibited. In one embodiment the means to inhibit the flow of gas through the voids is to form discontinuous voids. Hence, a void should not extend in the direction of the blade path longer than the cross-section of an impinging component, such as a turbine blade tip, that passes over the void. In this manner most of the voids can be sealed by the contacting blade tip as it passes over the void, and leakage can be minimized. Some voids, such as circular voids, are discontinuous closed-cell structures that can inherently optimize a seal at any given instant as the blade passes over an appropriately sized void.

Another means to achieve the seal is to replace the removed insulation with filler. Appropriate filler materials have a significantly higher abradability than the CMC. The abradability of the filled CMC surface is approximately the average of filler and the CMC. As the proportion of the CMC remaining upon patterning of the surface decreases and the dimensions of the voids increase, the greater the need becomes to seal the voids to prevent gas leakage by addition of filler. Where the discontinuous voids are large or are oriented with the long cross-section of the void in the direction of the blade cutting path, filler can be placed in the void to inhibit gas leakage through the void.

For all patterned surfaces the voids can include filler. By using the filler some of the practical limitations of the relative sizes of voids and the cross section of the blade tip are mediated, where in general the use of filler permits the formation of large voids. Appropriate filler ceramic materials include phosphates, silicates, zirconates and hafnates. Example compositions of these filler ceramic materials include monazite (yttrium phosphate), yttrium silicate, and gadolinium zirconate or gadolinium hafnate. Other examples of these and related oxides may include, but are not limited to: HfSiO₄, ZrSiO₄, Y₂O₃, ZrO₂, HfO₂, yttria and or rare earth partially or fully stabilized ZrO₂, yttria and/or rare earth partially Pr fully stabilized HfO₂, yttria and/or rare earth partially or fully stabilized ZrO₂/HfO₂, yttrium aluminum garnet (YAG); rare earth silicates of the form R₂Si₂O₇; oxides of the form R₂O₃; zirconates or hafnates of the form R₄Zr₃O₁₂ or R₄Hf₃O₁₂, where R may be one or more of Ce, Pr, Nd, Sm, Eu, Gd, Tb, Dy, Ho, Er, Tm, Yb, and Lu. The filler ceramic material is generally chosen based on the performance requirements of the filler in a given application. Preferably, the filler ceramic material is filled to the complete depth of the void to provide sealing in all areas including those where the blade tip rubs and those areas where the blade tip does not rub.

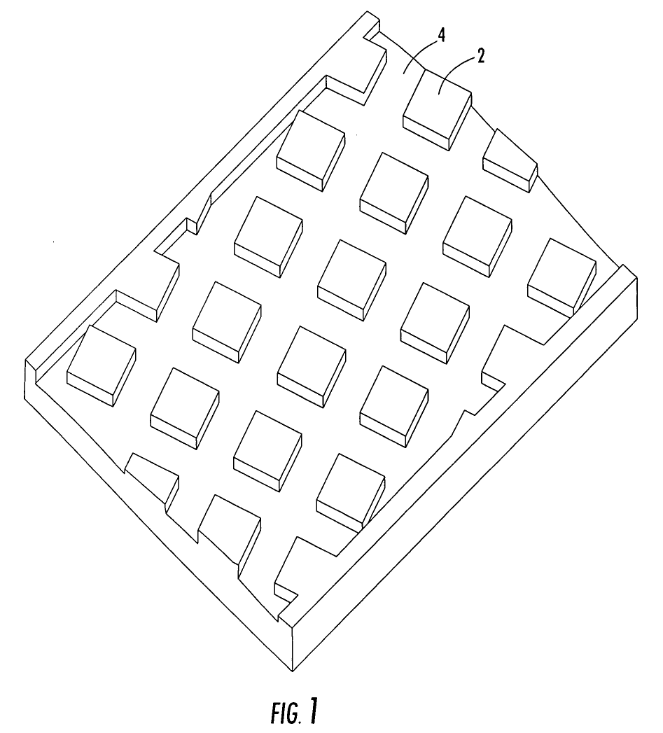

FIG. 1 illustrates a perspective view of a portion of a CMC component where the surface area is reduced by 67% by scribing a series of perpendicular cuts to leave squares 2 of composite material surrounded by voids 4 about the squares. The ratio of the length of the sides of the squares 2 to the minimum width of the voids 4 is 1.33. The percent reduction of the pre-patterned surface can be varied by changing the relative sizes of the squares and the width of the voids. When the ratio of the side of a square to the minimum width of the voids 4 is 1.71, more than 60% of the pre-patterned surface has been removed. When the ratio of the side of a square to the minimum width of the voids is 0.81 less than 80% of the pre-patterned surface has been removed. The proportion of surface that is occupied by voids depends upon the abradability of the CMC material and it is preferred to have 60 to 90% removal of the composite surface to achieve an approximately three-fold increase of abradability.

If the blade cutting path is parallel to a row of squares 2 of composite material, relatively high wear can occur to the portions of the blade that pass over the squares 2, but little or no wear could occur to the portions of the blade that pass primarily or exclusively over the voids 4. If the sides of the squares 2 are situated at 45-degrees to the blade cutting path, the wear to the blade would be greatest where the blade path bisects two opposite corner of the squares 2, and would be less to essentially absent midway between bisected corners, depending on the relative sizes of the squares 2 and the voids 4. As illustrated in FIG. 1, when the blade cutting path is parallel to the edge of the component and the sides of the squares 2 are 30-degrees relative to the edge, the difference in the amount of composite surface area that would be encountered by different points along the blade tip as it drawn across the surface of the composite is minimized. A second preferred orientation of the pattern is 60° C. relative to the sides when the blade cutting path is parallel to the sides. In this manner the blade most uniformly encounters composite and the blade tip wear is relatively uniform over the tip.

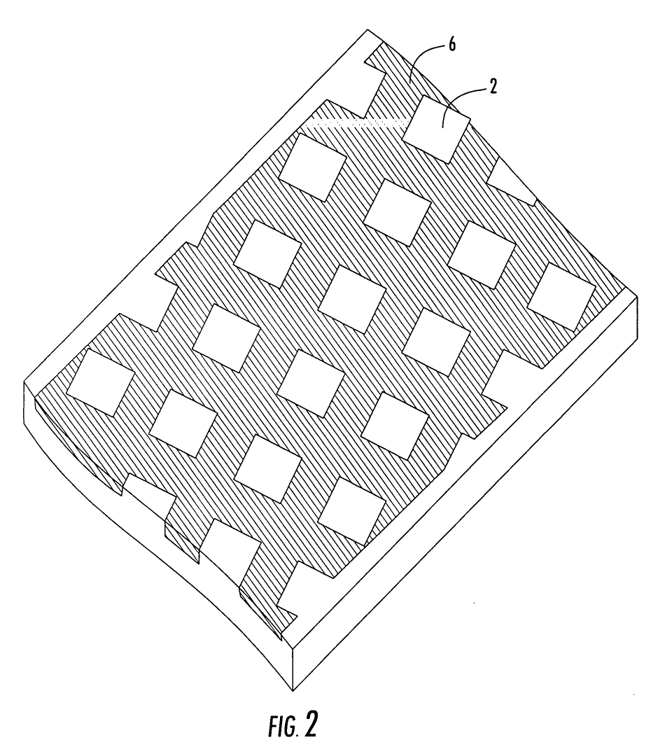

Because the voids, as shown in FIG. 1 are continuous and extend for a length that is significantly greater than the surface covered by the blade tip as it passes over the surface, the use of filler is needed to inhibit gas leakage. FIG. 2 shows the component where filler 6 has been placed in the voids. In this manner, a tight seal is maintained during the commissioning of the component when significant abrasion is taking place. A tight seal is maintained after commissioning even if the voids had been scribed to an anticipated abrasion depth in excess of the actual abrasion depth achieved.

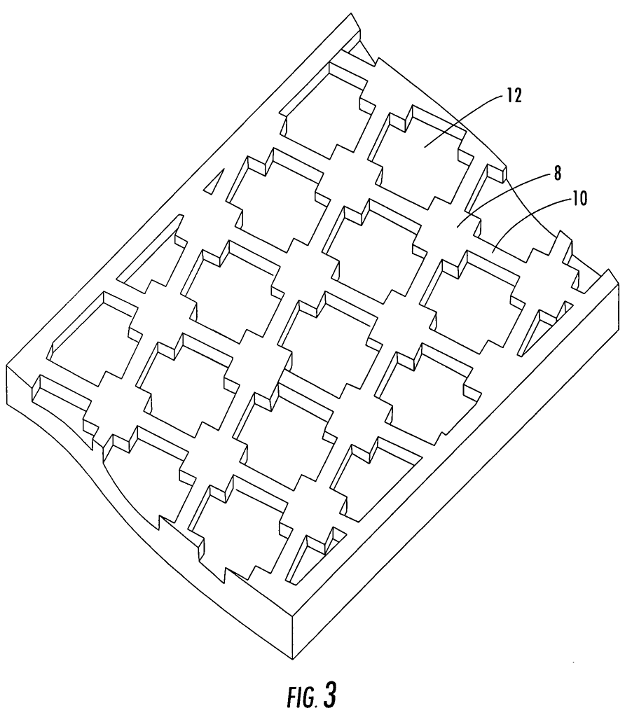

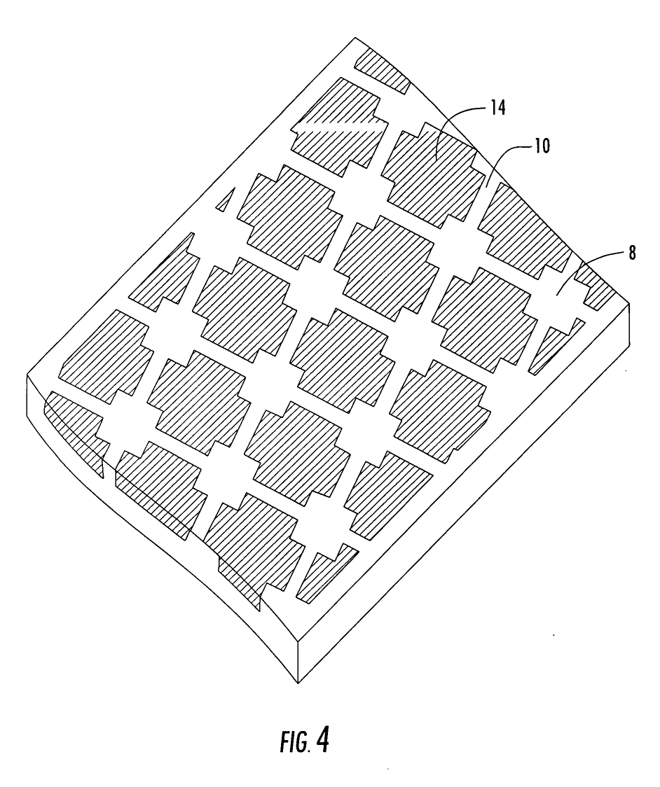

Another means to limit the leakage through the voids for a pattern of squares is to remove material such that the resulting squares 8 are connected via ligaments 10 as illustrated in FIG. 3. This results in the formation of discontinuous voids 12 in the shape of crosses cut into the composite. FIG. 3 illustrates voids 12 in the shape of cross with a minimum distance between parallel sides of adjacent squares 8 that is 100% of the sides of the squares 8 and ligaments 10 with a width of 25% of the sides of squares 8. In this case the surface has 63 percent voids. As the voids 12 are discontinuous, a good contact between a blade tip and a void without leakage of gases is possible. The blade tip wear is most uniform with a blade cutting path that is 30° or 60° relative to the sides of the squares. Unlike the squares generated by a series of continuous cuts, the means for inhibiting gas flow through the voids can be the discontinuity of the voids. However, as is illustrated in FIG. 4, filler 14 can be placed in the voids of the patterned component of FIG. 3 to further inhibit gas flow through the voids.

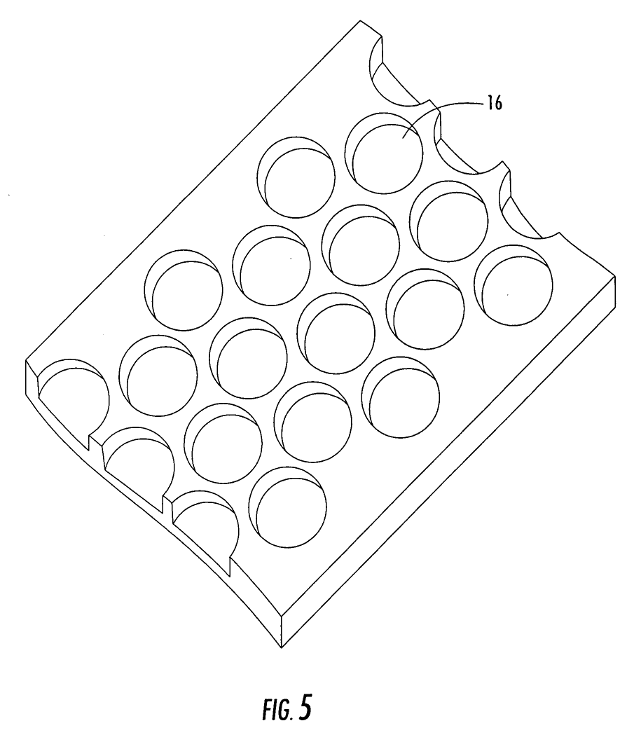

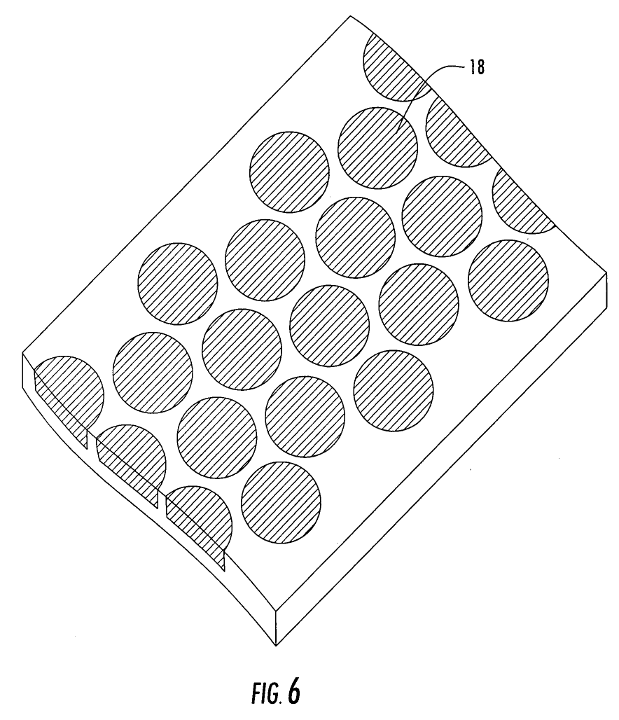

FIG. 5 illustrates a surface of discontinuous circular voids 16 with a diameter of the voids that is seven times that of the minimum width of composite between the voids 16. This pattern has 69% of the- pre-patterning surface area removed. The circular voids 16 are situated in rows perpendicular to the sides, with the centers of the circular voids 16 of one row situated at the mid-point between adjacent centers of the circular voids 16 of the adjacent rows. As the circular voids 16 are inherently discontinuous, the voids 16 can be sealed by the blade tip as it passes over the voids 6 when the circular voids 16 have a diameter of the width of the blade tip or less. No continuous line of composite material can be defined between the circular voids 16, and wear to the tip is essentially independent of the blade cutting path when the circular void 16 has a diameter that is large relative to the width of composite between the voids 16 as illustrated in FIG. 5. For any relative size of circular voids to insulation between the voids, an orientation of the rows of circular voids 16 to the side of the component is preferably 30-degrees or 90-degrees to a row of voids. These angles define orientations needed to assure most uniform wear of the blade tip for relatively small circular voids with relatively large widths of insulation between the voids. As the size of the circular voids increase the probability of gas leakage around the blade tip also increases and the addition of filler 18, as shown in FIG. 6, can further inhibit gas leakage with very large voids 16.

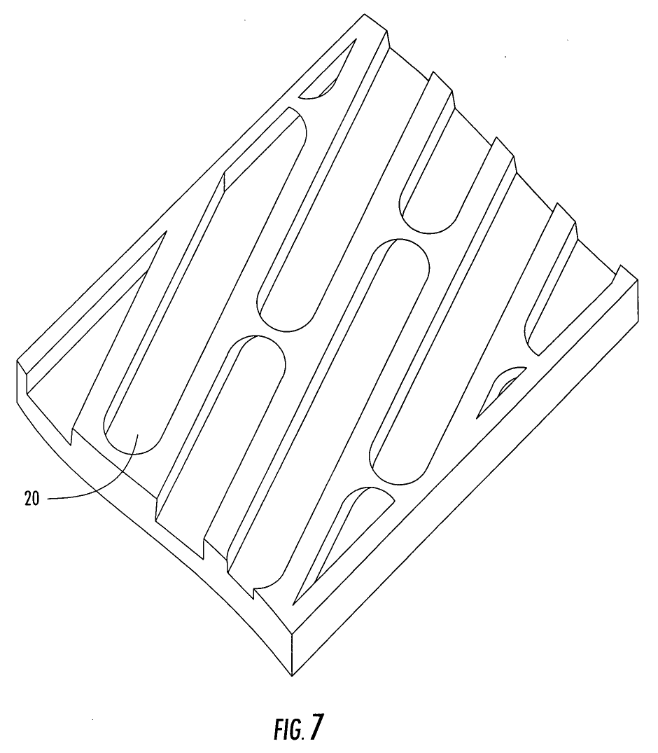

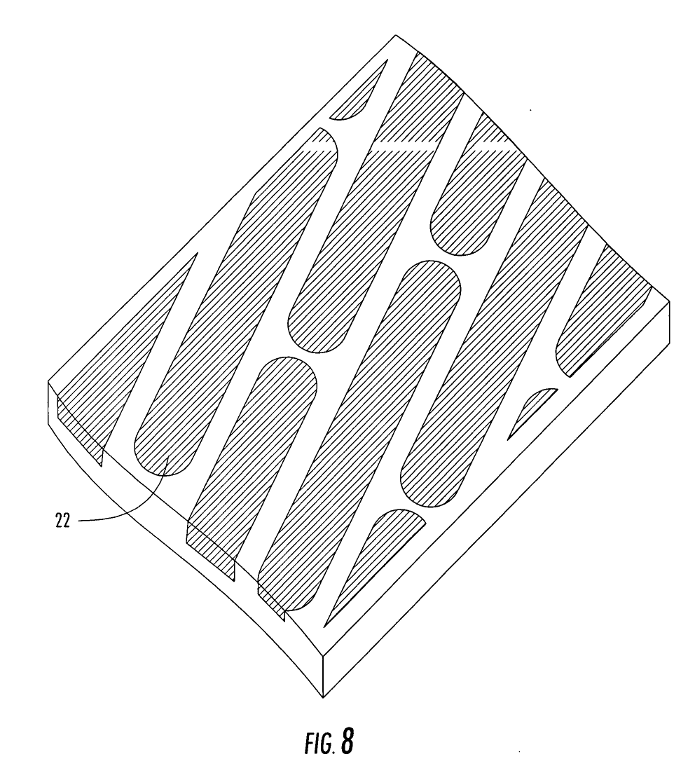

The shape of the voids can be elliptical as shown in FIG. 7. Again the pattern is discontinuous which limits leakage to some extent. FIG. 7 illustrates elliptical voids 20 of a width of three times the width of composite between the voids 20 and an elliptical void length of six times the width of the void 20. The pattern of FIG. 7 has surface area reduction of 70%. Again the most uniform wear to a blade tip will occur when the blade cutting path is 30 or 60-degrees relative to the length of the voids 20 and parallel to the side of the component as illustrated in FIG. 7. Again, as illustrated in FIG. 8, the addition of filler 22 to the discontinuous voids is preferred to inhibits leakage of gas as a blade passes over the surface.

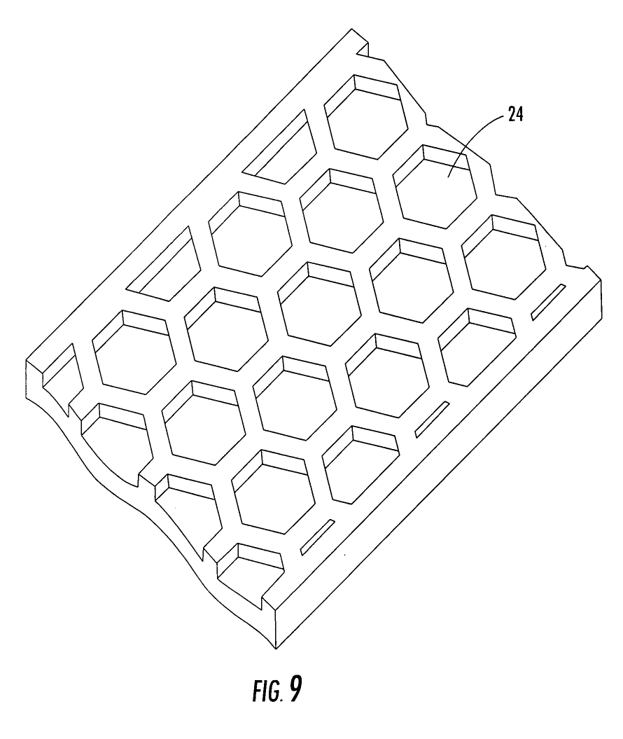

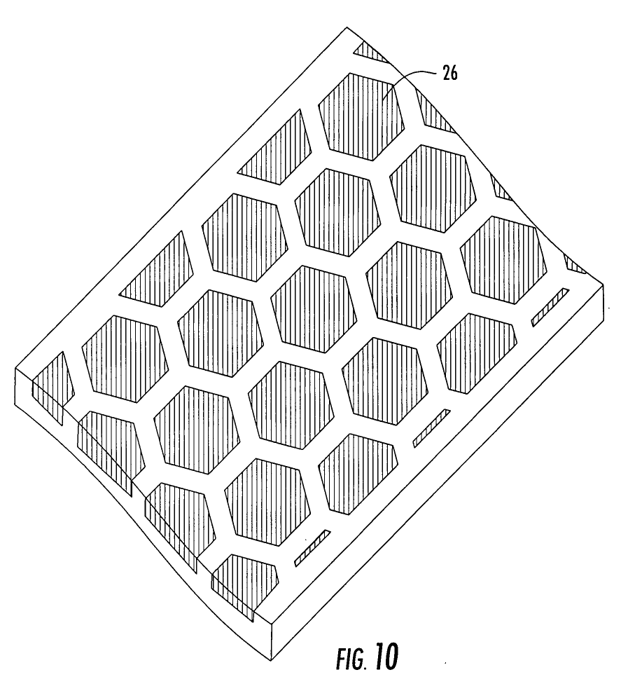

Another alternate pattern is that of hexagonal voids 24 that are cut into the surface, as illustrated in FIG. 9, with voids 24 with a side length of twice the width of composite between hexagons. In this case the voids 24 are 60% of the surface area. Again because the hexagonal voids are discontinuous, gas leakage can be minimal as the blade tip traverses the voids. Again, as shown in FIG. 10, filler 26 can be added to the voids to further inhibit leakage of gas during use of the abradable component.

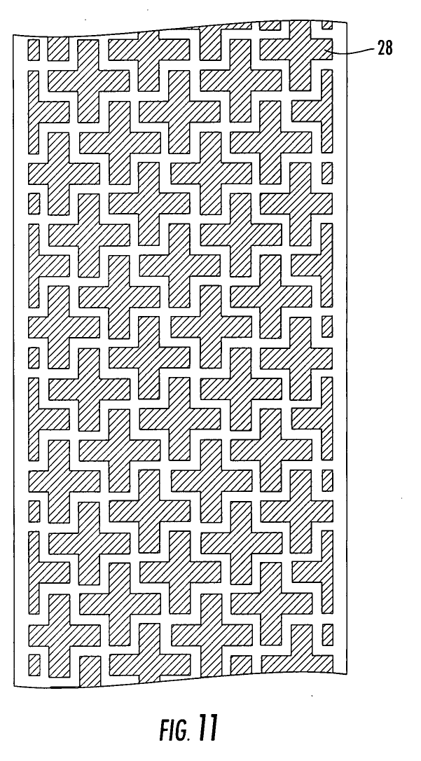

Other patterned surface can be formed that give discontinuous voids. FIG. 11 shows a surface with filled voids 28 in the shape of crosses disposed on the surface. In this illustration, the distance between parallel edges of two different voids 28 is 50% of the width of an arm of the void 28. This results in a 64% reduction in the surface.

The alternatives for the CMC and filling materials, patterns, depths of the voids, and other variations will be apparent to those skilled in the art and do not limit the scope of the invention. Variations and modifications can be made without departing from the scope and spirit of the invention as defined by the following claims.

We claim:

1. A ceramic matrix composite component with an abradable surface comprising:
a ceramic matrix composite with a pattern of solid composite material and voids, wherein the voids have a depth of less than the coating thickness and comprise 60 to 80 percent of said surface, and
a means to restrict gas flow through said void while an impinging blade tip passes over said void.

2. The component of claim 1, wherein said means to restrict gas flow comprises discontinuous voids wherein said voids have dimensions that essentially permit sealing of said void by said blade tip while passing over said void.

3. The component of claim 1, wherein said means to restrict gas flow comprises filler deposited in said void.

4. The component of claim 3, wherein said filler comprises a ceramic material.

5. The component of claim 4, wherein said ceramic material comprises phosphates, silicates, zirconates or hafnates.

6. The component of claim 1, wherein said pattern is a regular array of said solid composite material with square top surfaces surrounded by said void and said means to restrict gas flow comprises filler.

7. The component of claim 6, wherein rows of said square tops are aligned at a 30 or a 60 degree angle to the direction of the blade path.

8. The component of claim 1, wherein said pattern comprises a regular array of said solid composite material with square top surfaces connected by narrow ligaments partitioning said voids into discontinuous crosses and said means to restrict gas flow comprises discontinuous voids.

9. The component of claim 8, further comprising an additional means to restrict gas flow comprising filler.

10. The component of claim 8, wherein rows of said square tops are aligned at a 30 or a 60 degree angle to the direction of the blade path.

11. The component of claim 1, wherein said pattern comprises a regular array of circular voids surrounded by said solid composite material and said means to restrict gas flow comprises discontinuous voids.

12. The component of claim 11, further comprising an additional means to restrict gas flow comprising filler.

13. The component of claim 11, wherein rows of said circular voids are aligned at a 30 or a 90 degree angle to the direction of the blade path.

14. The component of claim 1, wherein said pattern comprises a regular array of hexagonal voids surrounded by said solid composite material wherein said means to restrict gas flow comprises discontinuous voids.

15. The component of claim 14, further comprising an additional means to restrict gas flow comprising filler.

16. The component of claim 1, wherein said pattern comprises a regular array of elliptical voids surrounded by said solid composite material wherein said means to restrict gas flow comprises discontinuous voids.

17. The component of claim 16, further comprising an additional means to restrict gas flow comprising filler.

18. The component of claim 16, wherein rows of said elliptical voids are aligned at a 30 or a 60 degree angle to the direction of the blade path.

19. The component of claim 1, wherein said pattern is a regular array of cross shaped voids surrounded by solid composite material wherein said means to restrict gas flow comprises discontinuous voids.

20. The component of claim 16, further comprising an additional means to restrict gas flow comprising filler.
